(19) United States
(12) Patent Application Publication
(10) Pub. No.: US 2021/0119935 A1
(43) Pub. Date: Apr. 22, 2021

(54) OBJECTIVE DRIVEN ORCHESTRATION

(71) Applicants: Thijs Metsch, Bruehl (DE); Rahul Khanna, Portland, OR (US); Ravishankar R. Iyer, Portland, OR (US); Mrittika Ganguli, Chandler, AZ (US)

(72) Inventors: Thijs Metsch, Bruehl (DE); Rahul Khanna, Portland, OR (US); Ravishankar R. Iyer, Portland, OR (US); Mrittika Ganguli, Chandler, AZ (US)

(21) Appl. No.: 17/132,882

(22) Filed: Dec. 23, 2020

(51) Int. Cl. H04L 12/927; H04L 12/24; H04L 12/66

(52) U.S. Cl. CPC H04L 47/805; H04L 12/66; H04L 41/5003

(57) ABSTRACT

Systems and techniques for an objective driven orchestration are described herein. In an example, system is adapted to receive a request for a service workload, including a set of performance objectives for the service workload. The set of performance objectives may indicate Quality of Service (QoS) for the performance of the service workload. The system may be further adapted to determine a plan for the service workload. The plan may orchestrate a set of actions to fulfill the set of performance objectives. The system may be further adapted to initiate execution of the service workload in accordance with the set of actions of the plan. They system may be further adapted to monitor execution of the service workload for an effect associated with each action of the set of actions and compliance with the set of performance objectives.

### TECHNICAL FIELD

Embodiments described herein generally relate to orchestrating services on a computer system, specifically based on a set of objectives.

### BACKGROUND

Service Level Agreement (SLA) and Service Level Objectives (SLO) management approaches have been used in grid and cloud computing related setups for providing computer system services. Other techniques and methods include automatically mapping higher level key performance indicators (KPI) to lower level telemetry and platform features, as well as automatic characterization and fingerprinting of workloads to determine platform feature impact on deployment configurations.

Many approaches described may require properly defined resource requirements in the deployment manifest for a service request, such as the number of network interface card (NIC) ports, central processing units (CPU) and virtual CPUs, the amount of random access memory (RAM), and the number of replica workloads. These resource requirement requests may be fixed and may not apply to every environment or context. The usage of a particular platform's features may be hand-tuned and configured on a per use-case basis. Additionally, an even mapping between SLO and KPI for a single platform feature may be limiting, as there may be multiple actions and settings used in conjunction that may fulfill multiple objectives at once. A static approach to scheduling at the time of deployment may be limiting, as the required actuations may change over time and thus will need to be continuously managed.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

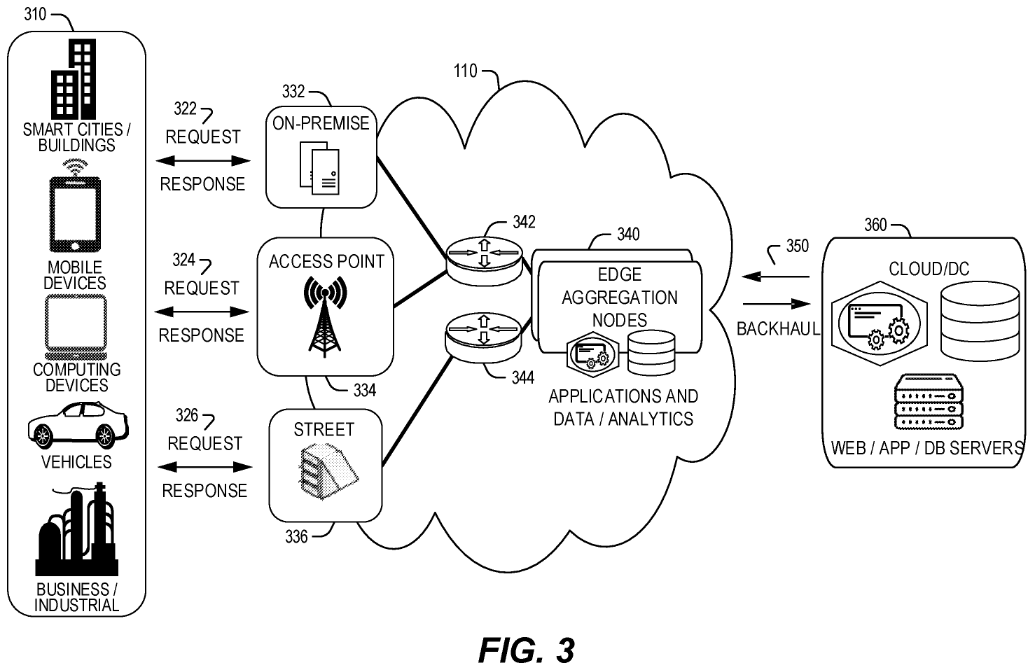

FIG. 4 illustrates the present usage model and proposed usage model 450 for workload deployment, in accordance with some embodiments.

FIG. 5 illustrates a flowchart for the objective driven orchestration, in accordance with some objectives.

FIG. 6 illustrates a flowchart showing a technique for objective driven orchestration, in accordance with some embodiments.

FIG. 7A provides an overview of example components for compute deployed at a compute node in an edge computing system.

FIG. 7B provides a further overview of example components within a computing device in an edge computing system.

FIG. 8 illustrates an example software distribution platform to distribute software.

### DETAILED DESCRIPTION

Providers of edge computing systems want their customers' services to perform as optimally as possible. Previously, customers may indicate the computing requirements of their services to the edge computing providers. However, this may not be the optimal configuration for the computing systems of the provider and may not translate optimal performance from one system to another. The systems and techniques described herein instead receive performance objectives that are used to determine a plan and optimal configuration for executing the service and service workload. Objectives may include latency, throughput, and availability or reliability requirements for the services and their workloads. The resulting plan may include actions such as triggering initial placement of workloads, re-balancing (e.g. migration and scaling of services) of the workloads, and tuning or policy settings for the platform.

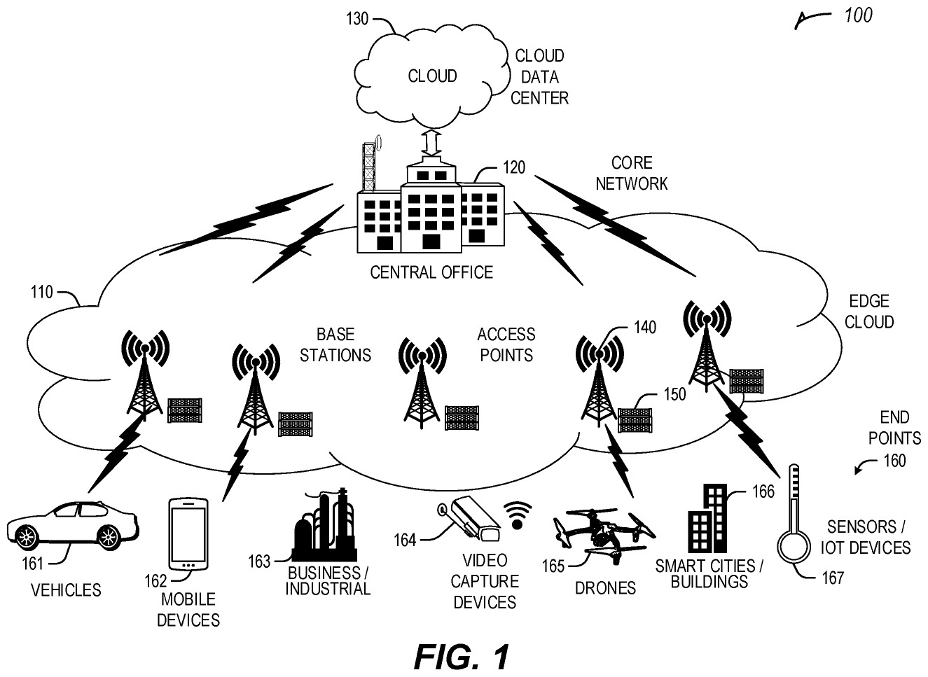

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration, and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

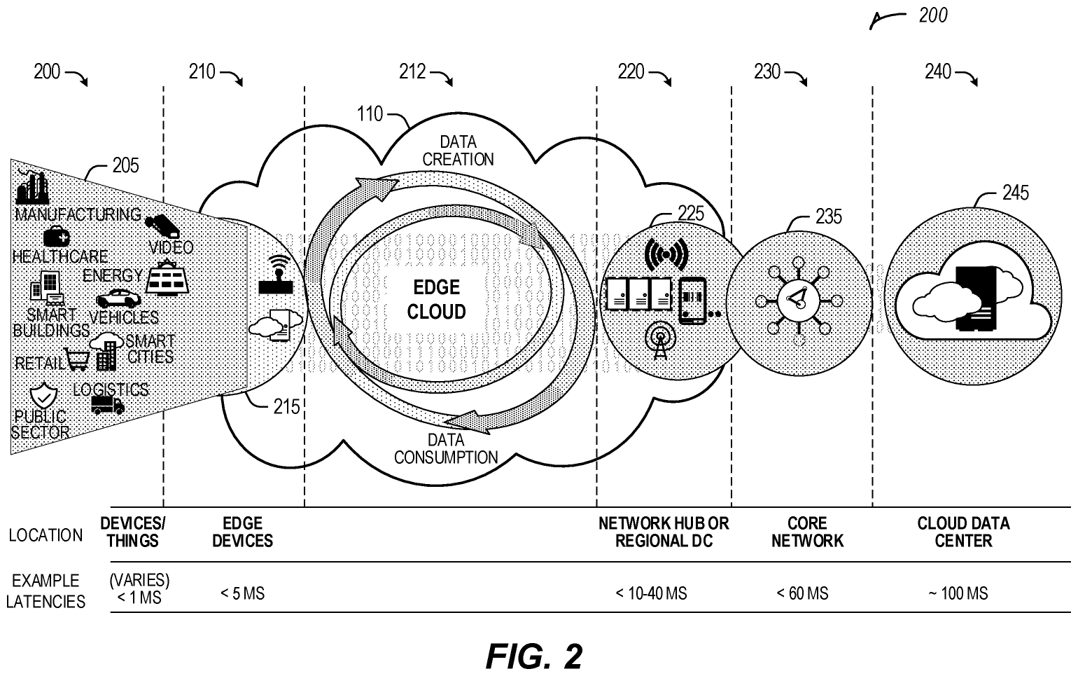

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. The edge cloud 110 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

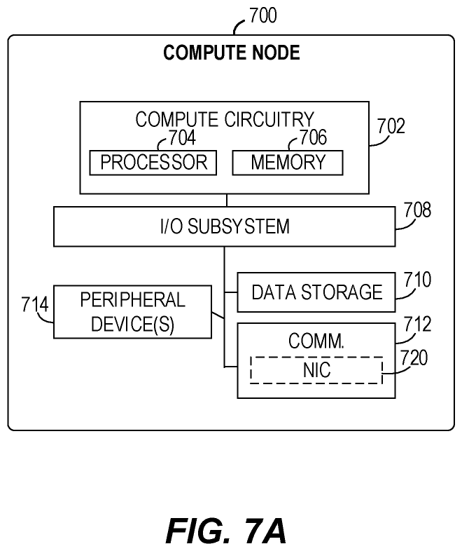

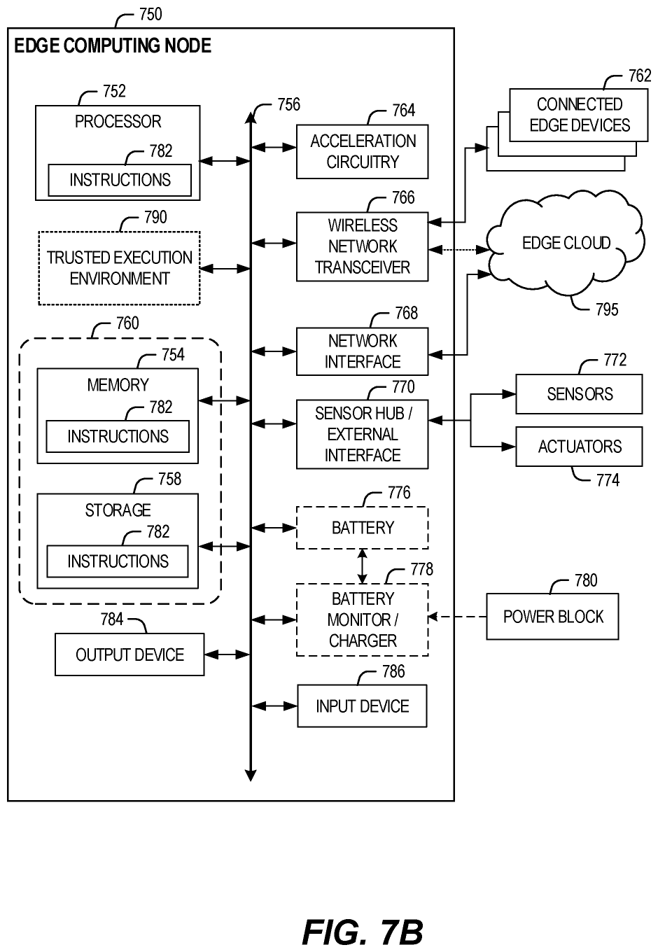

In FIG. 7, various client endpoints 710 (in the form of mobile devices, computers, autonomous vehicles, business computing equipment, industrial processing equipment) exchange requests and responses that are specific to the type of endpoint network aggregation. For instance, client endpoints 710 may obtain network access via a wired broadband network, by exchanging requests and responses 722 through an on-premise network system 732. Some client endpoints 710, such as mobile computing devices, may obtain network access via a wireless broadband network, by exchanging requests and responses 724 through an access point (e.g., cellular network tower) 734. Some client endpoints 710, such as autonomous vehicles may obtain network access for requests and responses 726 via a wireless vehicular network through a street-located network system 736. However, regardless of the type of network access, the TSP may deploy aggregation points 742, 744 within the edge cloud 110 to aggregate traffic and requests. Thus, within the edge cloud 110, the TSP may deploy various compute and storage resources, such as at edge aggregation nodes 740, to provide requested content. The edge aggregation nodes 740 and other systems of the edge cloud 110 are connected to a cloud or data center 760, which uses a backhaul network 750 to fulfill higher-latency requests from a cloud/data center for websites, applications, database servers, etc. Additional or consolidated instances of the edge aggregation nodes 740 and the aggregation points 742, 744, including those deployed on a single server framework, may also be present within the edge cloud 110 or other areas of the TSP infrastructure.

For FaaS and managed services trending toward being serverless, there is a shift with how services and their workloads are deployed. Deployment manifests for containers and functions may not include requirements for resources and platform features. This may affect the performance of a service if certain features are not utilized and no specific features are requested by service developers.

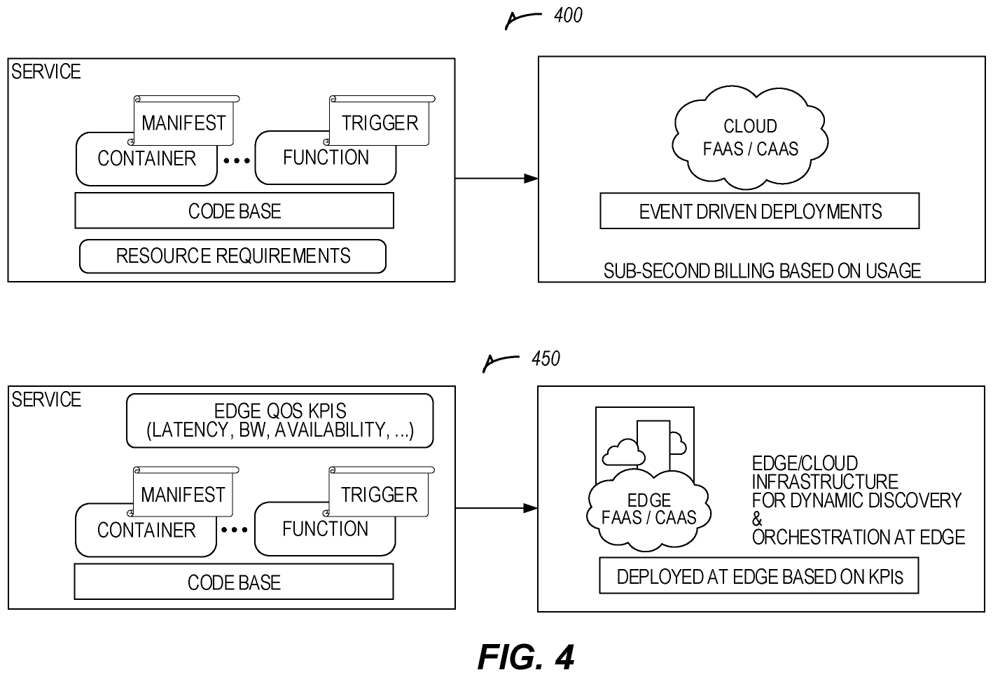

FIG. 4 illustrates the present usage model 400 and proposed usage model 450 for workload deployment, in accordance with some embodiments. The present usage model 400 receives a service, such as from a client, which is deployed to the cloud. In the present usage model 400, billing may be based on usage at sub-second intervals. Thus, it is in the client's best interest to receive optimal performance for such intricate billing. However, in many situations, the client or developer does not own or manage any of the workload infrastructure. The client's lack of ownership of the actual infrastructure the workload is implemented on may result in the client requesting less than optimal resources.

The present usage model 400 where resource requirements may be provided by the client may result in less than optimal performance. The client may have developed and tested the service on their own computing systems, such as laptops, which may not be as powerful as the servers that will executing the service in deployment. Additionally, servers may vary, and the client may not want to be locked in with a single vendor. Thus, the resources for a configuration with one vendor may not be the same configuration for the servers of another vendor. By not having an optimal resource configuration, the client may be overpaying for what they need or constraining the performance and workflow rate of their service.

The client instead provides QoS KPIs, or objectives, for the service in the proposed usage model 450. Utilizing the systems and techniques herein, dynamic discovery and orchestration is performed for the edge could infrastructure to determine an optimal resource configuration to achieve the objectives. The service is deployed based on these objectives and the determined orchestration. Especially for services that may require low latency, high throughput, and high levels of availability, as may be found in industrial implementations, it may be key for the QoS KPIs to be clearly defined and confirmed during orchestration.

QoS KPIs, or objectives, may be, but are not limited to latency, deadlines, throughput, and reliability related requirements. Objectives may include tolerations and priorities. Tolerations may enable the system to potentially violate objectives for a short timespan to achieve a better overall goal. A toleration may generally indicate the strictness of the objectives in place. Priorities may be defined to indicate the importance of the objectives in relation to other objectives.

A client may not be aware of all the features available on a platform, thus having the client specify the resources for the service may overlook features that would ensure optimal performance of their service. By having the client specify objectives instead and developing a plan to achieve those objectives, the features and resources that may not be known to the client may be utilized.

The systems and techniques described here in for objective-driven orchestration may be useful for resources deployed at the edge as it may adjust for resource constraint requirements of the services. The objective-driven orchestration may reduce the risk of over-provisioning when running mixed critical workloads in multi-tenant environment and overall enable tighter consolidation of workloads at the edge.

The systems and techniques described herein incorporate a planning component to the service orchestration and workload, in combination with a monitor and an information core. These components may be added to an existing control plane, such as Kubernetes. A control plane may be used for container-orchestration to automate application deployment, scaling, and management. Control planes with autonomic features may aid with an objective driven process of managing workloads. Platforms may have feature differentiations where the planning component may provide for adapting to each platform without the burden of static hand-tunings which do not scale or adapt to changes in context. This may be applicable on many levels as a plan may include tuning actions for lower level platform settings or configurations, such as tuning CPU Last Level Cache (LLC).

The planning component may be provided with a set of objectives to determine an optimal plan that contains a set of actions to be performed to fulfil the objectives. The main task of the planning component is to map the objectives into an actionable plan. The plan may comprise of a set of actions that are then being fulfilled by the overall control plan. Example actions as part of a plan may be to migrate a workload, tune the cache for a workload, or scale a workload. A control plane may be in charge of the scheduling and execution of a workload.

Along with the planning component, may be a monitor and an information core. The monitor may be used to track the current state the services on the platform and the state of the set of objectives for each service. The monitor may be used to determine the effect a plan has on the objectives associated with a service or workload. The information core includes insights and plan models that detail the effect an action within a plan has on an objective. For example, the information core may include plan models that demonstrate how scaling up may reduce latency of the service.

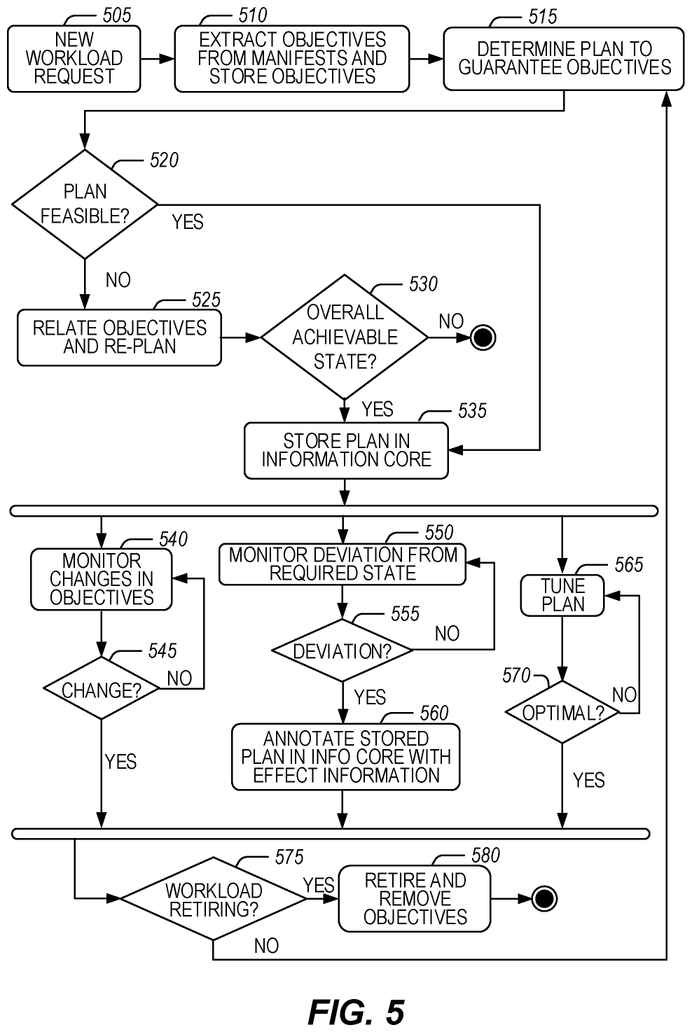

FIG. 5 illustrates a flowchart 500 for the objective-driven orchestration, in accordance with some objectives. At operation 505, the planning component may receive a new workload request. The planning component is constructed, designed, or implemented with hardware resources, such as an application specific integrated circuit (ASIC), field-programmable gate array (FPGA), programmable logic, or other circuitry. The workload request may include the service or application to be implemented with deployment manifests for deploying and executing. The deployment manifest may include performance objectives and schedules. At operation 510, the objectives are extracted from the deployment manifest and stored.

At operation 515, the planning component determines a plan for the workload that will achieve the provided performance objectives. The planning component translates the performance objectives into an actionable plan. This may include using the scheduler load to determine what types of actions may be available. The planner utilizes the plan models of the information core to model the plan and determine if the plan will achieve the objectives.

The plan modelling may be tuned, selected, or modified using a machine learning model. For example, the information core may include a set of plan models and performance results that correspond to each plan and workload service. The machine learning model may be used to determine estimated performance results for a given plan. The machine learning model may be trained with the set of plan models and the corresponding performance results. The machine learning model may then be provided a plan determined by the planning component for the current workload request. The machine learning model may then generate an estimate of the performance results for the provided plan. The estimated performance results may be compared to the objectives to determine if the plan will meet the objectives.

A machine learning model may be used to generate a plan. The information core may include a set of plan models, which include the performance results of the plan model and how the plan was executed, such as the type of platform and the number of replica workloads. This plan model data may be used to train the machine learning model. The machine learning model may then be provided as input the requested objectives and the platform for the service workload. The machine learning model may then generate a plan for the service workload based on the objectives and the platform.

The planning component may be able to perform actions such as migrating, pausing, suspending, preempting, and killing workloads. The planning component may enforce policies and trigger actuations on the platform level. The planning component may reserve resources, such as based on scheduling or priorities. The planning component may generate more than one plan for a workload. For example, in order to fulfill the client request for their service, the workload may be implemented on multiple platforms. Thus, for each platform variation a plan may be generated that most closely achieves the objectives based on that platform.

Planning algorithms may be used to determine a set of actions, or a plan, for fulfilling the received objectives. Given the current state of a workload, the planning algorithms may determine the necessary actions for achieving the goal state. The goal states may be defined by the received objectives for one or more workloads. The planning and scheduling algorithms may utilize artificial intelligence, algorithms such as State Space Search, Constraint Satisfaction Problems, Backtracking, Genetic Algorithms, and Min-conflict algorithms. can be used. The anytime algorithm and heuristic algorithm may be used to provide insights or feedback on the effects of actions on the planning algorithms.

The planning component may generate a plan to run experiments to test the effect of certain actions in relation to the objectives for a given workload. For example, the experiments may be based on when a low load on the services is detected or there is free capacity. This may enable the planning component to build up the knowledge base in the information core and allow for more detailed decision in future. Bayesian optimization techniques may be used to achieve this. The knowledge base, or information core, stores models and information that describes how a workload will behave based on different factors and actions that occur with the workload. The models stored in the information core may include metadata that identifies the relationship between the objective results of the models and a platform configuration.

At decision 520, a determination is made if the plan is feasible. This may be based on the platform having the resources to perform as specified by the plan. This may be based on the other workloads currently executing on the platform. At operation 525, the planning component may relate the objectives with the present limitations of the platform and determine a new plan. At decision 530, a determination is made if the provided objectives are achievable under the revised plan. If at decision 530 it is determined that the objectives are not achievable for the provided workload request, then the planning and orchestration ends. The client may be notified that the workload and objectives are not feasible. The workload may be reassigned to another platform that may be able to achieve the requested objectives. If at decision 520 it is determined the plan is feasible or at decision 530 that there is an overall achievable state for the objectives with the current plan, then the plan is stored in the information core at operation 535.

Once the plan is executed for the workload, a monitoring component begins monitoring the performance to ensure the objectives are being met. The monitoring component is constructed, designed, or implemented with hardware resources, such as an application specific integrated circuit (ASIC), field-programmable gate array (FPGA), programmable logic, or other circuitry. At operation 540, the monitoring component may monitor for changes in the objectives. The monitoring component may be used to identify changes in the objectives across all the workloads in the system. At decision 545, if no changes are identified, then the monitoring component continues to monitor for objective changes. At decision 545, if changes are identified, then a re-planning needs to occur and the state is returned to operation 515, if it is determined at decision 575 that the workload is not retiring, to determine a new plan based on the objective changes. The planning component may need to plan or re-plan as objectives change over time.

At operation 550, the monitoring component monitors for deviations from the required state of the plan to meet the objectives. At decision 555, if no deviation is detected, then the monitoring for deviations continues. At decision 555, if a deviation is identified, then at operation 560 the plan stored in the information core is annotated with the effects of the deviation. The deviation data may be valuable for identifying the effects with future models.

The monitoring component may determine the effect a set of actions from a plan has on the objectives. When actions are performed, the affect an action has on the objectives may be tracked in a database, such as the information core. Based on these tracked effects and changes the actions have on the objectives, statistical analytics, modelling, and machine learning algorithms may be used to build models capturing the effects of the set of actions. For example, a tracked effect may be how the number of replica workloads affect the latency of a service.

At operation 565, the monitoring component may check if the plan needs to be tuned. For example, the resource provider may perform a platform upgrade resulting in workloads needing to be migrated away to a different platform. In another example, the platform provider may change the operational mode, such as changing the cost of the execution of the workload or if there is a change in the SLA level of the customer. The monitoring component, at intervals or on events, checks if there are tunings to be made. At decision 570, if it is determined the plan is not performing optimally, then a return to operation 565 occurs to further tune the plan. The optimal determination may be based on the objectives. If the objectives are not being met, then the execution of the plan for the service workload may not be performing optimally. For example, replicas may be added or removed to adjust the latency objective.

As context changes, such as a change in load on the service/workloads, neighboring workloads changing behavior, or workload failures, the planning component may be triggered to optimize the configuration. For example, in a case where the load of the service decreases, the number of replica workloads may be reduced while still fulfilling the objectives. This enables efficient use of sparse and constraint resources in the system and a reduction in the potential cost for the service owners. At decision 570, if the workload is performing optimally, then it continues until completion.

When the workload completes, at decision 575 a determination is made if the workload is retiring, based on if the service workload has completed. A service workload may be complete based on time, such as being implemented for two weeks. The service workload may be based on processing cycles, such as if the service workload has met the total number of processing cycles the client has contracted. If the workload is not retiring, then it may be returned to operation 515 to determine if the current plan is meeting the objectives or if a new plan should be generated. The data from a previous performance stored in the information core may be used to generate a new plan. If decision 575 determines that the workload is retiring, then at operation 580 the workload is retired and the objectives are removed from the planning component. The workload is completed.

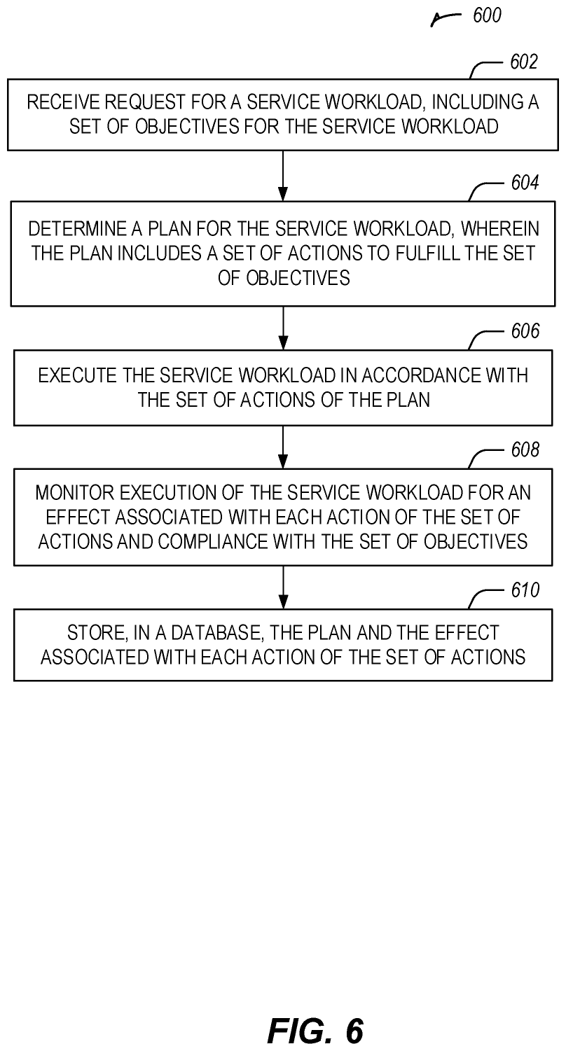

FIG. 6 illustrates a flowchart showing a technique 600 for objective-driven orchestration, in accordance with some embodiments. The technique 600 includes an operation 602 to receive a request for a service workload, including a set of objectives for the service workload. The service workload may be a service implemented on an edge computing system. The set of objectives may include objectives based on latency, throughput, or availability of resources.

The technique 600 includes an operation 604 to determine a plan for the service workload. The plan may include a set of actions to fulfill the set of objectives. The actions may include migrating, pausing, suspending, preempting, and killing workloads. The plan may be determined using a plurality of plan models.

As an example, the plan may be determined using an Anytime Dynamic A* search algorithm to determine the set of actions to fulfill the objectives for a workload. For example, this may use a graph model in which the nodes represent the states the objectives are in and the edges are actions that may be triggered. To generate the successor states of a given state, the models that describe the effects of an action may be used to predict the follow-up states.

Once a state graph is completed, a search may be performed. The weight of the graph edges, indicating the actions, may be determined using utility functions and multiple attribute utility theory (MAUT). The shortest path between the current state and goal state, or objective, based on these weights/utilities may determine the plan.

The plan models are based on actions and the resulting effects. Plan models may apply differently to different platforms and the features available on each platform. The plan models may be generated with Bayesian optimization using actions and associated effects. The plan models may be generated using machine learning with actions and associated effects used to train the machine learning model.

The technique 600 may further include an operation to identify if the plan is feasible or infeasible for an execution platform. If the plan is determined to be infeasible for the execution platform, then the technique 600 may further include an operation to determine a new plan for the service workload based on the execution platform and the set of objectives.

The technique 600 includes an operation 606 to execute the service workload in accordance with the set of actions of the plan. The technique 600 includes an operation 608 to monitor execution of the service workload for an effect associated with each action of the set of actions and compliance with the set of objectives.

The technique 600 may further include an operation to identify an alteration to the set of objectives. As the execution of the service workload is being monitored, a change in objective may be received or identified. The technique 600 may further include an operation to determine a second plan for the service workload based on the alteration to the set of objectives. The change in objectives may necessitate the plan be updated.

The technique 600 may further include an operation to identify a deviation from at least one objective of the set of objectives. As the service workload executes, if the monitoring determines that one of the objectives is not being met, then the plan may be adjusted to ensure the objectives are met. The technique 600 may further include an operation to alter the set of actions of the plan based on the deviation. Utilizing the stored models, actions from the models may be identified for updating the plan to meet the objectives.

The technique 600 includes an operation 606 to store, in a database, the plan and the effect associated with each action of the set of actions. The database may include previous actions and result effects, including platforms and configuration associated with each of the actions. This stored data may be used to generate the plan models.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in a cloud (e.g., an edge cloud 795) via local or wide area network protocols. The wireless network transceiver 766 may be a low-power wide-area (LPWA) transceiver that follows the IEEE 802.15.4, or IEEE 802.15.4g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or to other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include A processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, Calif., among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

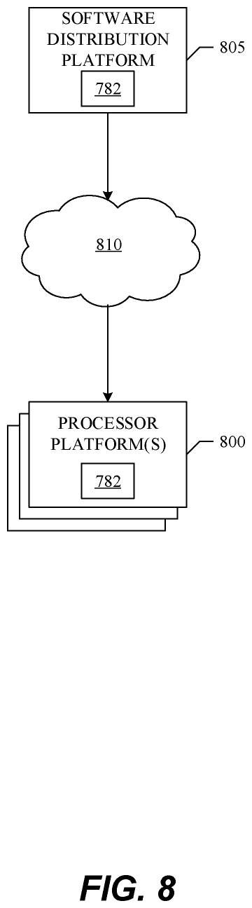

FIG. 8 illustrates an example software distribution platform 805 to distribute software, such as the example computer readable instructions 782 of FIG. 7B, to one or more devices, such as example processor platform(s) 800 and/or example connected edge devices 762. The example software distribution platform 805 may be implemented by any computer server, data facility, cloud service, etc., capable of storing and transmitting software to other computing devices (e.g., third parties, the example connected edge devices 762 of FIG. 7B). Example connected edge devices may be customers, clients, managing devices (e.g., servers), third parties (e.g., customers of an entity owning and/or operating the software distribution platform 805). Example connected edge devices may operate in commercial and/or home automation environments. In some examples, a third party is a developer, a seller, and/or a licensor of software such as the example computer readable instructions 782 of FIG. 7B. The third parties may be consumers, users, retailers, OEIs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 8, the software distribution platform 805 includes one or more servers and one or more storage devices. The storage devices store the computer readable instructions 782, which may correspond to the example computer readable instructions 782 of FIG. 7B, as described above. The one or more servers of the example software distribution platform 805 are in communication with a network 810, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 782 from the software distribution platform 805. For example, the software, which may correspond to the example computer readable instructions 782 of FIG. 7B, may be downloaded to the example processor platform(s) 800 (e.g., example connected edge devices), which is/are to execute the computer readable instructions 782 to implement the technique 600 for objective-driven orchestration. In some examples, one or more servers of the software distribution platform 805 are communicatively connected to one or more security domains and/or security devices through which requests and transmissions of the example computer readable instructions 782 must pass. In some examples, one or more servers of the software distribution platform 805 periodically offer, transmit, and/or force updates to the software (e.g., the example computer readable instructions 782 of FIG. 7B) to ensure improvements, patches, updates, etc. are distributed and applied to the software at the end user devices.

In the illustrated example of FIG. 8, the computer readable instructions 782 are stored on storage devices of the software distribution platform 805 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 782 stored in the software distribution platform 805 are in a first format when transmitted to the example processor platform(s) 800. In some examples, the first format is an executable binary in which particular types of the processor platform(s) 800 can execute. However, in some examples, the first format is uncompiled code that requires one or more preparation tasks to transform the first format to a second format to enable execution on the example processor platform(s) 800. For instance, the receiving processor platform(s) 800 may need to compile the computer readable instructions 782 in the first format to generate executable code in a second format that is capable of being executed on the processor platform(s) 800. In still other examples, the first format is interpreted code that, upon reaching the processor platform(s) 800, is interpreted by an interpreter to facilitate execution of instructions.

### ADDITIONAL NOTES & EXAMPLES

Example 1 is a system for objective-driven orchestration, the system comprising: at least one processor; and memory including instructions that, when executed by the at least one processor, cause the at least one processor to: receive a request for a service workload, including a set of performance objectives for the service workload, wherein the set of performance objectives indicate Quality of Service (QoS) for the performance of the service workload; determine a plan for the service workload, wherein the plan orchestrates a set of actions to fulfill the set of performance objectives; initiate execution of the service workload in accordance with the set of actions of the plan; monitor execution of the service workload for an effect associated with each action of the set of actions and compliance with the set of performance objectives.

In Example 2, the subject matter of Example 1 includes, wherein the system is incorporated into an edge gateway.

In Example 3, the subject matter of Examples 1-2 includes, wherein the system is incorporated into a network router.

In Example 4, the subject matter of Examples 1-3 includes, wherein the plan for the service workload includes a schedule of resources in an edge network reserved for operations to satisfy the service workload and meet the performance objectives.

In Example 5, the subject matter of Examples 1-4 includes, wherein the set of performance objectives includes an objective based on at least one of latency, throughput, or availability.

In Example 6, the subject matter of Examples 1-5 includes, instructions to: identify the plan is infeasible for an execution platform, based on capabilities of the execution platform for performing the plan; and determine a new plan for the service workload based on the capabilities of the execution platform and the set of performance objectives.

In Example 7, the subject matter of Examples 1-6 includes, instructions to: receive a second set of performance objectives; and determine a second plan for the service workload based on the second set of performance objectives.

In Example 8, the subject matter of Examples 1-7 includes, instructions to: identify a deviation of the execution of the service workload from at least one objective of the set of performance objectives; and alter the set of actions of the plan based on the deviation.

In Example 9, the subject matter of Examples 1-8 includes, instructions to store, in a database, the plan and the effect associated with each action of the set of actions.

Example 10 is at least one non-transitory machine-readable medium including instructions for objective-driven orchestration that, when executed by at least one processor, cause the at least one processor to perform operations to: receive a request for a service workload, including a set of performance objectives for the service workload, wherein the set of performance objectives indicate Quality of Service (QoS) for the performance of the service workload; determine a plan for the service workload, wherein the plan orchestrates a set of actions to fulfill the set of performance objectives; initiate execution of the service workload in accordance with the set of actions of the plan; monitor execution of the service workload for an effect associated with each action of the set of actions and compliance with the set of performance objectives.

In Example 11, the subject matter of Example 10 includes, wherein the system is incorporated into an edge gateway.

In Example 12, the subject matter of Examples 10-11 includes, wherein the system is incorporated into a network router.

In Example 13, the subject matter of Examples 10-12 includes, wherein the plan for the service workload includes a schedule of resources in an edge network reserved for operations to satisfy the service workload and meet the performance objectives.

In Example 14, the subject matter of Examples 10-13 includes, wherein the set of performance objectives includes an objective based on at least one of latency, throughput, or availability.

In Example 15, the subject matter of Examples 10-14 includes, instructions that, when executed by the at least one processor, cause the at least one processor to perform operations to: identify the plan is infeasible for an execution platform, based on capabilities of the execution platform for performing the plan; and determine a new plan for the service workload based on the capabilities of the execution platform and the set of performance objectives.

In Example 16, the subject matter of Examples 10-15 includes, instructions that, when executed by the at least one processor, cause the at least one processor to perform operations to: receive a second set of performance objectives; and determine a second plan for the service workload based on the second set of performance objectives.

In Example 17, the subject matter of Examples 10-16 includes, instructions that, when executed by the at least one processor, cause the at least one processor to perform operations to: identify a deviation of the execution of the service workload from at least one objective of the set of performance objectives; and alter the set of actions of the plan based on the deviation.

In Example 18, the subject matter of Examples 10-17 includes, instructions that, when executed by the at least one processor, cause the at least one processor to perform operations to store, in a database, the plan and the effect associated with each action of the set of actions.

Example 19 is a method for objective-driven orchestration, comprising: receiving a request for a service workload, including a set of performance objectives for the service workload, wherein the set of performance objectives indicate Quality of Service (QoS) for the performance of the service workload; determining a plan for the service workload, wherein the plan orchestrates a set of actions to fulfill the set of performance objectives; initiating execution of the service workload in accordance with the set of actions of the plan; monitoring execution of the service workload for an effect associated with each action of the set of actions and compliance with the set of performance objectives.

In Example 20, the subject matter of Example 19 includes, wherein the system is incorporated into an edge gateway.

In Example 21, the subject matter of Examples 19-20 includes, wherein the system is incorporated into a network router.

In Example 22, the subject matter of Examples 19-21 includes, wherein the plan for the service workload includes a schedule of resources in an edge network reserved for operations to satisfy the service workload and meet the performance objectives.

In Example 23, the subject matter of Examples 19-22 includes, wherein the set of performance objectives includes an objective based on at least one of latency, throughput, or availability.

In Example 24, the subject matter of Examples 19-23 includes, identifying the plan is infeasible for an execution platform, based on capabilities of the execution platform for performing the plan; and determining a new plan for the service workload based on the capabilities of the execution platform and the set of performance objectives.

In Example 25, the subject matter of Examples 19-24 includes, receiving a second set of performance objectives; and determining a second plan for the service workload based on the second set of performance objectives.

In Example 26, the subject matter of Examples 19-25 includes, identifying a deviation of the execution of the service workload from at least one objective of the set of performance objectives; and altering the set of actions of the plan based on the deviation.

In Example 27, the subject matter of Examples 19-26 includes, storing, in a database, the plan and the effect associated with each action of the set of actions.

Example 28 is a system for objective-driven orchestration, the system comprising: means for receiving a request for a service workload, including a set of performance objectives for the service workload, wherein the set of performance objectives indicate Quality of Service (QoS) for the performance of the service workload; means for determining a plan for the service workload, wherein the plan orchestrates a set of actions to fulfill the set of performance objectives; means for initiating execution of the service workload in accordance with the set of actions of the plan; means for monitoring execution of the service workload for an effect associated with each action of the set of actions and compliance with the set of performance objectives.

In Example 29, the subject matter of Example 28 includes, wherein the system is incorporated into an edge gateway.

In Example 30, the subject matter of Examples 28-29 includes, wherein the system is incorporated into a network router.

In Example 31, the subject matter of Examples 28-30 includes, wherein the plan for the service workload includes a schedule of resources in an edge network reserved for operations to satisfy the service workload and meet the performance objectives.

In Example 32, the subject matter of Examples 28-31 includes, wherein the set of performance objectives includes an objective based on at least one of latency, throughput, or availability.

In Example 33, the subject matter of Examples 28-32 includes, means for identifying the plan is infeasible for an execution platform, based on capabilities of the execution platform for performing the plan; and means for determining a new plan for the service workload based on the capabilities of the execution platform and the set of performance objectives.

In Example 34, the subject matter of Examples 28-33 includes, means for receiving a second set of performance objectives; and means for determining a second plan for the service workload based on the second set of performance objectives.

In Example 35, the subject matter of Examples 28-34 includes, means for identifying a deviation of the execution of the service workload from at least one objective of the set of performance objectives; and means for altering the set of actions of the plan based on the deviation.

In Example 36, the subject matter of Examples 28-35 includes, means for storing, in a database, the plan and the effect associated with each action of the set of actions.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for objective-driven orchestration, the system comprising:
at least one processor; and
memory including instructions that, when executed by the at least one processor, cause the at least one processor to:
receive a request for a service workload, including a set of performance objectives for the service workload, wherein the set of performance objectives indicate Quality of Service (QoS) for performance of the service workload;
determine a plan for the service workload, wherein the plan orchestrates a set of actions to fulfill the set of performance objectives;
initiate execution of the service workload in accordance with the set of actions of the plan;
monitor execution of the service workload for an effect associated with each action of the set of actions and compliance with the set of performance objectives.

2. The system of claim 1, wherein the system is incorporated into an edge gateway.

3. The system of claim 1, wherein the system is incorporated into a network router.

4. The system of claim 1, wherein the plan for the service workload includes a schedule of resources in an edge network reserved for operations to satisfy the service workload and meet the performance objectives.

5. The system of claim 1, wherein the set of performance objectives includes an objective based on at least one of latency, throughput, or availability.

6. The system of claim 1, further comprising instructions to:
identify the plan is infeasible for an execution platform, based on capabilities of the execution platform for performing the plan; and
determine a new plan for the service workload based on the capabilities of the execution platform and the set of performance objectives.

7. The system of claim 1, further comprising instructions to:
receive a second set of performance objectives; and
determine a second plan for the service workload based on the second set of performance objectives.

8. The system of claim 1, further comprising instructions to:
identify a deviation of the execution of the service workload from at least one objective of the set of performance objectives; and
alter the set of actions of the plan based on the deviation.

9. The system of claim 1, further comprising instructions to store, in a database, the plan and the effect associated with each action of the set of actions.

10. At least one non-transitory machine-readable medium including instructions for objective-driven orchestration that, when executed by at least one processor, cause the at least one processor to perform operations to:
receive a request for a service workload, including a set of performance objectives for the service workload, wherein the set of performance objectives indicate Quality of Service (QoS) for performance of the service workload;
determine a plan for the service workload, wherein the plan orchestrates a set of actions to fulfill the set of performance objectives;
initiate execution of the service workload in accordance with the set of actions of the plan;
monitor execution of the service workload for an effect associated with each action of the set of actions and compliance with the set of performance objectives.

11. The at least one non-transitory machine-readable medium of claim 10, wherein the plan for the service workload includes a schedule of resources in an edge network reserved for operations to satisfy the service workload and meet the performance objectives.

12. The at least one non-transitory machine-readable medium of claim 10, wherein the set of performance objectives includes an objective based on at least one of latency, throughput, or availability.

13. The at least one non-transitory machine-readable medium of claim 10, further comprising instructions that, when executed by the at least one processor, cause the at least one processor to perform operations to:
receive a second set of performance objectives; and
determine a second plan for the service workload based on the second set of performance objectives.

14. The at least one non-transitory machine-readable medium of claim 10, further comprising instructions that, when executed by the at least one processor, cause the at least one processor to perform operations to:
identify a deviation of the execution of the service workload from at least one objective of the set of performance objectives; and
alter the set of actions of the plan based on the deviation.

15. The at least one non-transitory machine-readable medium of claim 10, further comprising instructions that, when executed by the at least one processor, cause the at least one processor to perform operations to store, in a database, the plan and the effect associated with each action of the set of actions.

16. A method for objective-driven orchestration, comprising:
receiving a request for a service workload, including a set of performance objectives for the service workload, wherein the set of performance objectives indicate Quality of Service (QoS) for performance of the service workload;
determining a plan for the service workload, wherein the plan orchestrates a set of actions to fulfill the set of performance objectives;
initiating execution of the service workload in accordance with the set of actions of the plan;
monitoring execution of the service workload for an effect associated with each action of the set of actions and compliance with the set of performance objectives.

17. The method of claim 16, wherein the plan for the service workload includes a schedule of resources in an edge network reserved for operations to satisfy the service workload and meet the performance objectives.

18. The method of claim 16, wherein the set of performance objectives includes an objective based on at least one of latency, throughput, or availability.

19. The method of claim 16, further comprising:
receiving a second set of performance objectives; and
determining a second plan for the service workload based on the second set of performance objectives.

20. The method of claim 16, further comprising:
identifying a deviation of the execution of the service workload from at least one objective of the set of performance objectives; and
altering the set of actions of the plan based on the deviation.
